(19) United States
(12) Patent Application Publication
(10) Pub. No.: US 2007/0204024 A1
(43) Pub. Date: Aug. 30, 2007

(54) Mapping managing devices to managed devices

(76) Inventors: Roger T. Baird, Boise, ID (US); Timothy P. Blair, Boise, ID (US)

Correspondence Address: HEWLETT-PACKARD COMPANY;Intellectual Property Administration, P.O. Box 272400, Ft. Collins, CO, 80527-2400, US

(21) Appl. No.: 11/511,178

(22) Filed: Aug. 28, 2006

Related U.S. Application Data
(63) Continuation of application No. 10/056,203, filed on Jan. 25, 2002.

(51) Int. Cl. G06F 15/16

(52) U.S. Cl. 709/223

(57) ABSTRACT

Mapping managing devices to managed devices includes checking an amount of time taken by a managing device to service a managed device is checked. Based at least in part on the amount of time taken by the managing device to service the managed device, a determination is made as to whether the managing device is a desired manager of the managed device.

### RELATED APPLICATIONS

This application is a continuation of U.S. patent application Ser. No. 10/056,203, filed Jan. 25, 2002, which is hereby incorporated by reference herein.

### TECHNICAL FIELD

This invention relates generally to networks and device management, and more particularly to mapping managing devices to managed devices.

### BACKGROUND

As computing technology has advanced, computers have become increasingly commonplace in homes, businesses, educational facilities, and elsewhere. Computers have also become increasingly interconnected via networks, such as local area networks (LANs), the Internet, and so forth. Networking computers together can be very beneficial as it allows the computers to communicate with one another as well as share network devices, such as printers or scanners.

It is anticipated that some network devices will become increasingly managed or serviced by other network devices, allowing the managing devices to obtain information regarding the operation of the managed devices. For example, printers on a network may be managed by multiple different network servers, each of which periodically services one or more of the printers to obtain the operation information.

In order for a set of managing devices to service a set of other devices, a mapping of managing devices to managed devices is used to determine which managing device services which managed device(s). A need exists to generate such a mapping. One solution is to have the mapping manually generated by a system administrator. However, this solution is user (administrator) unfriendly and is burdensome on the system administrator. Another solution is a brute force method where each managing device accesses each of the managed devices for the sole purpose of determining how quickly each managed device can be serviced by each managing device, and then all of this information is collected and used as the basis for a determination as to which managing devices should service which managed devices. However, this solution requires a significant amount of network overhead with all of the device accesses, and furthermore must be repeated each time a managing device or managed device is added to or removed from the network, each time a change in the network architecture occurs, etc.

The mapping managing devices to managed devices described herein helps solve these as well as other problems.

### SUMMARY

Mapping managing devices to managed devices is described herein.

In one embodiment, an amount of time taken by a manager device to service another device is checked. Based at least in part on the amount of time taken by the manager device to service the other device, a determination is made as to whether the manager device is a desired manager of the other device.

### BRIEF DESCRIPTION OF THE DRAWINGS

FIG. 1 illustrates an exemplary environment in which the mapping managing devices to managed devices can be employed.

FIG. 2 illustrates an exemplary device manager and devices in additional detail.

FIGS. 3 and 4 are flowcharts illustrating exemplary processes for selecting devices to service and maintaining a device service table.

FIG. 5 illustrates an exemplary computer in additional detail.

### DETAILED DESCRIPTION

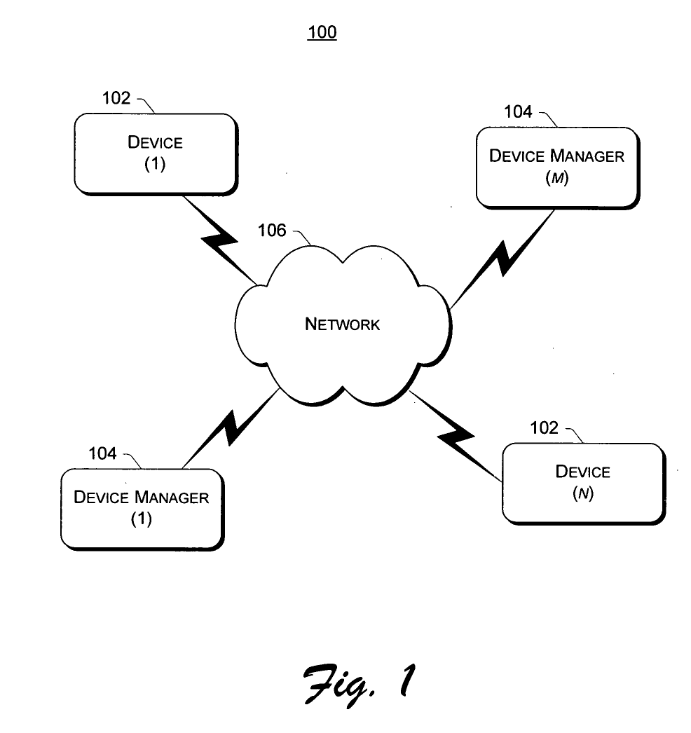

FIG. 1 illustrates an exemplary environment 100 in which the mapping managing devices to managed devices can be employed. In environment 100, multiple (n) managed devices 102 and multiple (m) device managers 104 are coupled together via a network 106. Network 106 is intended to represent any of a wide variety of conventional network topologies and types (including wired (e.g., twisted pair, coax, etc.) and/or wireless (e.g., RF, infrared, etc.) networks, employing any of a wide variety of network protocols (including public and/or proprietary protocols). Network 106 may include local area networks (LANs), wide area networks (WANs), and/or other networks, and may optionally include portions of the Internet.

Devices 102 can be the same or different types of devices. For example, devices 102 may include printers, scanners, multi-function devices (e.g., including both printing and scanning capabilities), modems, set-top boxes, consumer electronics devices, other types of computing devices (e.g., client workstations), etc. Device managers 104 can be any of a wide variety of computing devices, such as desktop computers, server computers, portable computers, etc. Each device manager 104 may have other functionality within environment 100 (e.g., as a file server, an electronic mail server, a user's desktop computer, etc.), or alternatively may be a dedicated management device (e.g., whose sole responsibility in environment 100 is the servicing of devices 102).

Servicing of a device refers to obtaining information regarding operation of the device (e.g., one or more metrics relating to usage of the device). The exact information obtained can vary by implementation, based on the types of devices being managed and/or the desires of the manufacturer(s) of the devices 102 or managers 104. Examples of such information that can be obtained include a number of pages printed or scanned, an amount of time the device has been powered-on, an amount of ink or toner used, whether a service door has been opened, whether an input tray is currently empty, whether the device is currently functional or an error has occurred in the device, how long a particular user has been logged in to the device, application(s) that have been executing on the device, how long a particular application has been executing (e.g., in total, while a particular user is logged in, etc.), etc. As used herein, servicing of a device and managing of a device are interchangeable.

In addition to obtaining information from the device being serviced, the device managers may also communicate information to the device. For example, a request to reset a counter of number of pages printed or scanned may be sent to the device as part of the servicing.

Each of the devices 102 is serviced by one or more of the device managers 104. For each device 102, a particular one of the device managers 104 is deemed to be the desired manager for the device 102. Each device 102 is typically serviced by its desired manager 104, but at various intervals will also be serviced by other managers 104. Which other managers and at what intervals this servicing by other managers will be done is based on a trigger condition, as discussed in more detail below. If one of these other managers, in response to the trigger condition being satisfied, services the device at least a threshold amount of time faster than the current desired manager 104 for that device, then that manager becomes the new desired manager for the device. Over time, the mapping of desired managers to devices will have, for most if not all of the devices, the manager (or one of the managers) that can service a device faster than the other managers be the desired manager for that device.

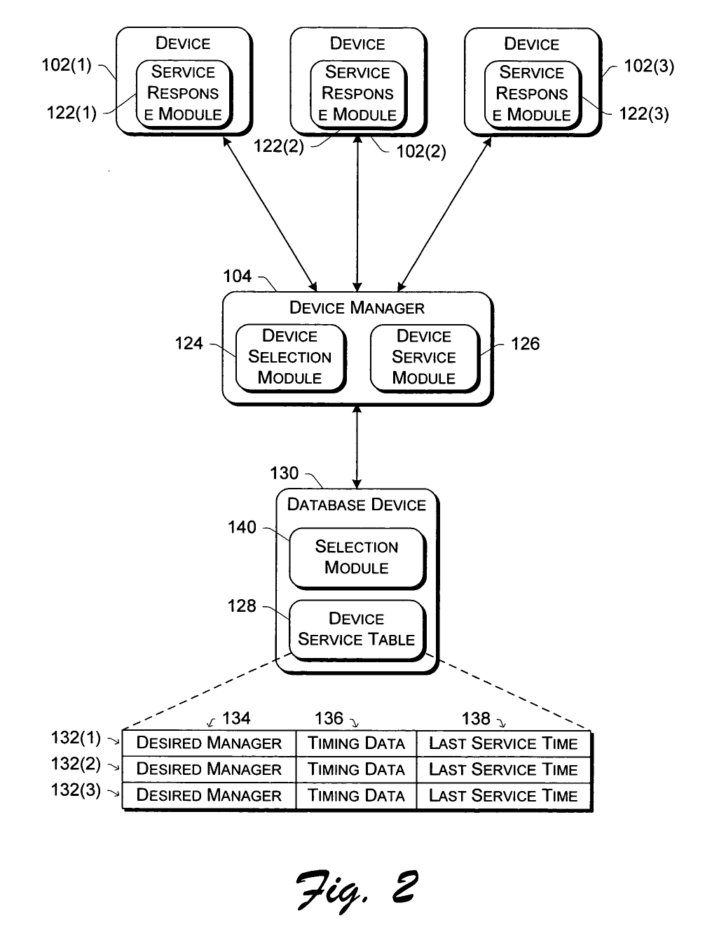

FIG. 2 illustrates an exemplary device manager 104 and devices 102 in additional detail. For ease of explanation, only one device manager and three devices are illustrated in FIG. 2; it is to be appreciated that multiple additional device managers and devices may also be coupled together.

Three devices 102(1), 102(2), and 102(3) are illustrated, each including a service response module 122(1), 122(2), and 122(3), respectively. Device manager 104 includes a device selection module 124 and a device service module 126. Device service module 126 operates to service, at regular or irregular intervals, one or more of devices 102(1), 102(2), and 102(3). Which of the devices 102(1), 102(2), and 102(3) is selected for servicing at any particular time is determined by device selection module 124 and is discussed in more detail below. When servicing a device 102, device service module 126 communicates a service request to the service response module 122 of the device being serviced. Service response module 122 gathers the appropriate information, and optionally performs various functions in response to the service request. A particular function to be performed (e.g., re-set a page counter) may be specifically identified in the request, or may be inherent based on the request (e.g., service response module 122 always resets a page counter in response to a service request). The gathered information is then returned to device service module 126. The gathered information can then be used in any of a wide variety of manners (e.g., communicated to another device, stored in a log, used to determine whether to notify an administrator of a problem or potential problem, etc.).

Device selection module 124 determines which device to service based in part on a device service table 128. Each device manager 104 has access to device service table 128, directly and/or indirectly. In the illustrated example, device service table 128 is maintained by a central database device 130, and device manager 104 obtains a copy of the table (or portions of the table) from database device 130. Alternatively, a copy of device service table 128 may be maintained at each of device managers 104, with the device managers 104 being responsible for maintaining synchronization of the table copies (e.g., each time a manager 104 makes a change to a table the change is communicated to the other managers 104).

Device service table 128 includes one entry for each device 102, illustrated as entries 132(1), 132(2), and 132(3). Each entry includes a desired manager field 134, a timing data field 136, and a last service time 138.

Desired manager field 134 includes an indication of the desired manager of the device, thereby mapping the entry and corresponding device to a particular device manager. This indication can be in any of a wide variety of formats, such as a device name, a network address of the device, etc. During initialization of table 128, a particular device manager 104 is assigned (e.g., by database device 130) to be the desired manager. This assignment may be random, may be based on some information about the manager 104 and/or the device 102 (e.g., their network addresses), or some other criteria. As the desired manager of the device can change over time, if the device manager assigned as the desired manager is not a good choice (e.g., network communications between the device and the manager take a long amount of time), this can be corrected over time.

Timing data field 136 indicates the amount of time taken to service the device by the current desired manager of the device. In one implementation, the amount of time taken to service the device refers to the amount of time that elapses between device service module 126 sending the service request and receiving the desired operation information from the device (thus accounting for network latencies both from manager 104 to device 102 and from device 102 to manager 104). In alternate implementations, the amount of time taken to service the device can be measured in different ways. For example, different starting points for the amount of elapsed time could be used, such as when device selection module 124 begins the determination process of which device to select (thus accounting for latencies in device manager 104), or when service response module 122 sends the operation information (e.g., module 122 including a timestamp with the operation information that identifies when module 122 sent the information), and so forth. Different ending points for the amount of elapsed time could also be used, such as when the request is received by device 102 (e.g., the service response module 122 or other component of device 102 would determine the time of receipt of the service request and return the time of receipt along with the operation information to device manager 104), or when device selection module 124 finishes writing any necessary information back to device service table 128.

During initialization of table 128, the timing data fields 136 may be left empty, or alternatively some default value may be assigned. Each time that the desired manager of the device is changed, the amount of time taken to service the device by the new desired manager is written into the timing data field 136.

Last service time field 138 includes an indication (e.g., time and date) of when the device was last serviced. It should be noted that this is simply an indication of when the device was last serviced, and there is no indication of which device manager actually serviced the device (e.g., it may or may not have been the desired manager indicated in field 134).

In an alternate embodiment, rather than keeping track of the time the device was last serviced, a data structure with an inherent order is used to maintain the entries 132 (e.g., a linked list, an array, etc.). A pointer or other identifier that indicates the next table entry (and thus the next device to be serviced) can be maintained. The pointer or identifier advances from table entry to table entry as devices are serviced. Thus, in this situation, the last service time field 138 need not be included in table 128.

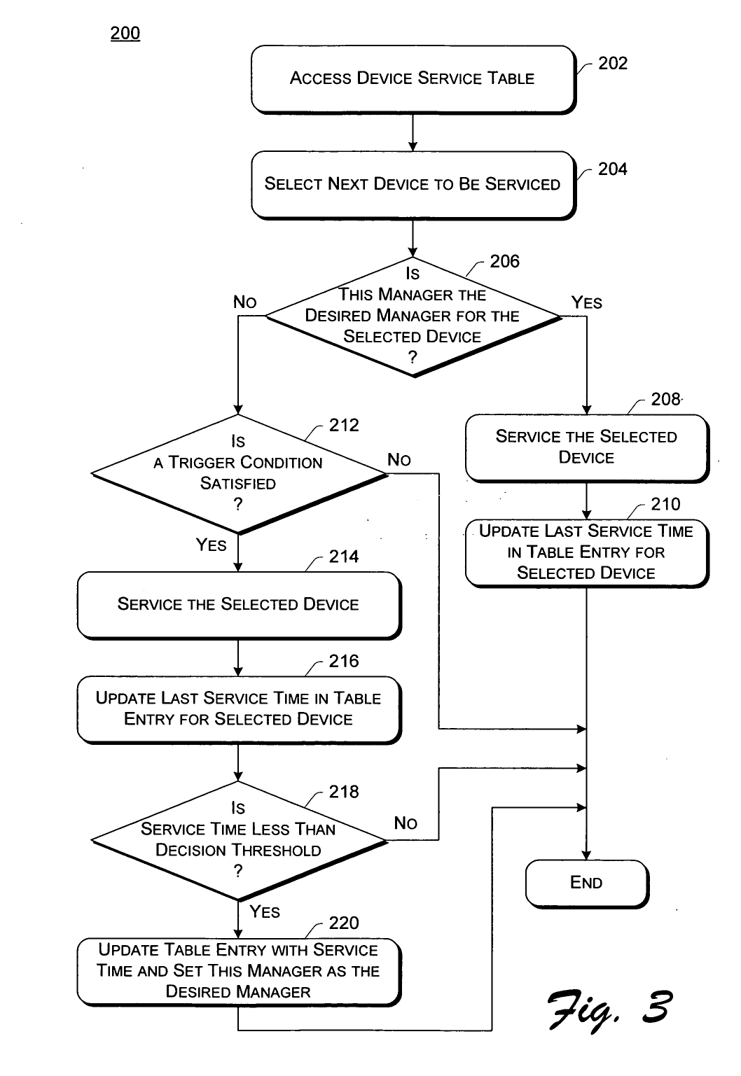

FIG. 3 is a flowchart illustrating an exemplary process 200 for selecting devices to service and maintaining a device service table. The process of FIG. 3 is implemented by device selection module 124 of FIG. 2, and may be performed in software. FIG. 3 will be discussed with additional reference to elements of FIG. 2.

Device selection module 124 is invoked (by itself or alternatively by some other module) at regular or irregular intervals to service devices 102. Each time module 124 is invoked, it selects one of the devices 102 for servicing by device service module 126. For example, device selection module 124 may select a device (the same device or different devices) for servicing every five seconds, every five minutes, once per day, whenever it has “down” time (e.g., is not currently processing any other tasks), etc. Alternatively, device selection module 124 may select a device for servicing after a particular amount of time (e.g., one day) has passed since the most recent servicing of a device (e.g., any device) based on the last service times in fields 138 of table 128.

When it is time for device selection module 124 to select a device 102 for servicing, device selection module 124 accesses device service table 128 (act 202) and selects the next device to be serviced (act 204). The next device to be serviced can be determined in a variety of different manners. In one implementation, module 124 searches table 128 to identify the table entry (and thus the corresponding device) having the oldest last service time in field 138. In another implementation, a pointer or other identifier is associated with device service table 128 and is used as an indication of the next device that is to be serviced.

Once a device is selected, module 124 checks whether the device manager 104 that it is part of is the desired manager for the selected device (act 206). This is accomplished by checking whether the device manager 104 is identified in desired manager field 134 of the table entry. If the device manager 104 is the desired manager for the selected device, then device service module 126 services the device (act 208) and updates the last service time in the table entry for the selected device (act 210). The last service time can be, for example, the date and time when manager 104 sends the service request to the device, the date and time when manager 104 receives the response to the service request from the device, etc. Alternatively, if there is no last service time field, then the point or other identifier of the next device to be serviced is updated appropriately, and the process ends (until invoked again).

Returning to act 206, if the device manager 104 is not the desired manager for the selected device, the device manager may nonetheless service the device. Whether it will service the device is dependent on whether a trigger condition is satisfied (act 212). The process is designed so that the trigger condition results in a device manager other than the desired manager servicing the next device to be serviced at various times. Different values for the trigger condition can be set, such as to achieve a result of a device manager other than the desired manager servicing the next device to be serviced 5% of the time (e.g., device selection module 124 generates a random number between 1 and 100 and the trigger condition is satisfied if the generated number is one of a set of trigger values, such as between 1 and 5, between 96 and 100, etc.), 8% of the time, etc.

If the trigger condition is not satisfied then the process ends (until invoked again). However, if the trigger condition is satisfied, then the selected device is serviced (act 214), and the last service time in the table entry for the selected device is updated (act 216). Alternatively, if there is no last service time field, then the point or other identifier of the next device to be serviced is updated.

Device selection module 124 then checks whether the amount of time taken to service the device is less than a decision threshold (act 218). The decision threshold is determined based on the amount of time indicated in timing data field 136. The decision threshold may be equal to the amount of time indicated in timing data field 136, or alternatively some amount of time less than the amount of time indicated in timing data field 136 (e.g., 100 ms less, 5% less, etc.).

If the amount of time taken to service the device is not less than the decision threshold (act 218), then the process ends (until invoked again). However, if the amount of time taken to service the device is less than the decision threshold, then the table entry for the device is updated with the timing data field 136 being the amount of time taken to service the device and the desired manager field 134 indicating this device manager (act 220). Processing then ends (until the process is invoked again).

Optionally, device selection module 124 may be configured so that devices are serviced at different intervals (e.g., hourly, daily, weekly, etc.). Different devices may be serviced at different intervals, or all devices may be serviced at the same interval. Device selection module 124 also takes into account whether a device is due for service in determining whether to service the device (acts 208 and 214), and services the selected device only if it is due for service. Whether a device is due for service is dependent on the time it was last serviced (e.g., as identified in last service time field 138 of FIG. 2) as well as the interval it is to be serviced at. For example, if a device is to be serviced hourly and the device has not been serviced for at least an hour, then the device is due for service; however, if the device was serviced 30 minutes ago, it is not due for service.

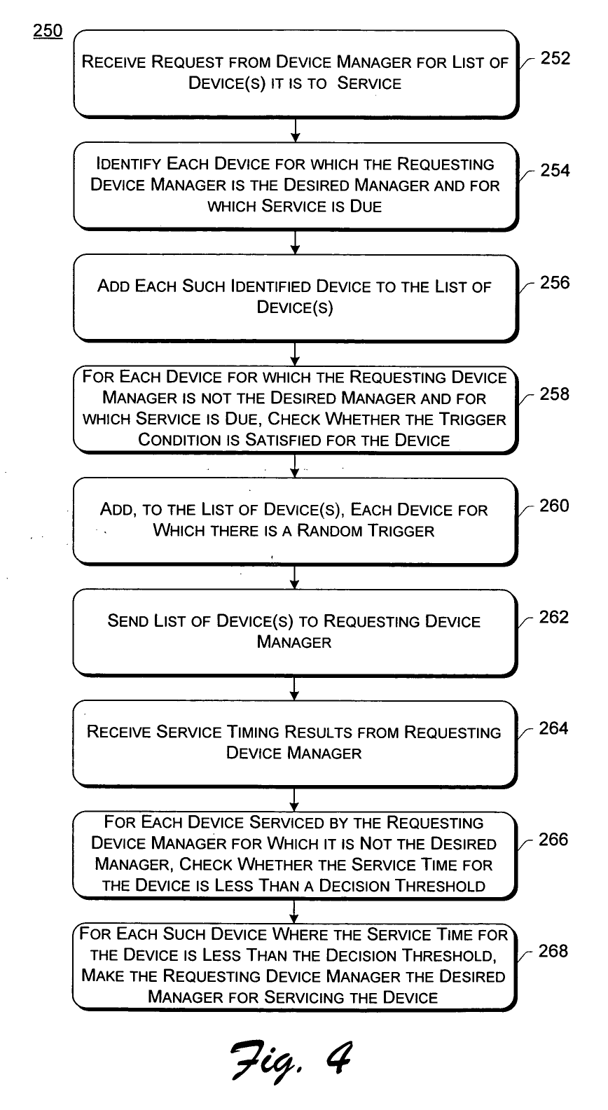

Returning to FIG. 2, the functionality of device selection module 124 may be included in database device 130 as selection module 140 rather than in device manager 104. In this situation, device manager 104 communicates a request to database device 130 for a list of devices that manager 104 is to service. Selection module 140 generates the list (accounting for the trigger condition) and returns the list to manager 104. This process is illustrated in additional detail in FIG. 4.

FIG. 4 is a flowchart illustrating an exemplary process 250 for selecting devices to service and maintaining a device service table. The process of FIG. 4 may be performed in software, and is discussed with additional reference to elements of FIG. 2.

Initially, selection module 140 receives a request from a device manager for a list of zero or more devices the manager is to service (act 252). Selection module 140 identifies, based on access device service table 128, each device for which the requesting device manager is the desired manager and for which service is due (act 254) and adds each such identified device to the list (act 256). Alternatively, selection module 140 may not base its decision on whether a particular device is due for service, and add all devices for which the requesting device manager is the desired manager in act 254 regardless of when they were due for service (although this may result in servicing devices more frequently than intended).

For each device for which the requesting device manager is not the desired manager and for which service is due, selection module 140 checks whether the trigger condition is satisfied for the device (act 258). Alternatively, selection module 140 may ignore whether service is due for a device analogous to the discussion above regarding act 254. This checking of whether the trigger condition in act 258 is satisfied is done analogous to that of act 212 in FIG. 3 discussed above. Selection module 140 then adds each device for which the trigger condition is satisfied to the list (act 260).

The list of devices is then sent to the requesting manager (act 262). Eventually, service timing results are returned to selection module 140 from the requesting manager (act 264). These service timing results are the times, for each of the devices serviced, taken to service the device. The time at which the device was serviced (e.g., staring of servicing, when servicing was completed, etc.) may also be returned to module 140 by the requesting manager. For each device serviced by the requesting device manager for which the manager is not the desired manager, a check is made as to whether the time taken to service the device is less than a decision threshold (act 266). This determination in act 266 is made analogous to that of act 218 in FIG. 3 discussed above. For each such device where the time taken to service the device is less than the decision threshold, the requesting device manager is made the desired manager for the device (act 268).

Thus, in the process of both FIGS. 3 and 4, the determination of desired managers for devices is determined based on the amount of time taken by the various device managers to service the various devices. Over time, the trigger condition will result in managers other than the desired manager servicing a particular device, and, depending on the resultant service timing information, can result in new desired managers. Thus, over time, the mapping of desired managers to devices will have, for most if not all of the devices, the manager that can service a device faster than the other managers be the desired manager for that device (if there are multiple managers that can service the device in approximately the same amount of time, but faster than other managers, one of these multiple managers will typically be the desired manager for that device).

Additionally, the determination of the desired managers is made based on communications that are inherent in the servicing system (that is, based on the service requests). The needed servicing is performed by the device managers, while at the same time the information to determine the desired managers is also gathered.

It should be noted that the determination of desired managers for devices automatically adapts to changes in the network architecture, to the addition or removal of devices, as well as to the addition or removal of device managers. For example, if a change occurs in the network that greatly increases the time taken for the current desired manager to service a particular device (e.g., removal or addition of particular switches, routers, bridges, etc.), eventually a trigger condition is highly likely to cause another device with a faster service time to service the device and become the new desired manager.

If a device is removed from the network its entry in table 128 is deleted (e.g., by a network administrator) and managers 104 will no longer attempt to service the device. If a device is added to the network, an entry for the new device is added to table 128 (e.g., by a network administrator, in response to an automatically discovered device based on an automatic device-discovery algorithm, etc.). A desired device manager may be assigned (e.g., randomly, or using the same process as was used to initialize table 128), or alternatively no device manager may be assigned (eventually, it is highly likely that a trigger condition will result in a device manager servicing the device and becoming the desired manager).

If a device manager is removed from the network, table 128 is searched to identify each entry 132 for which the removed manager is identified as the desired manager. For each such entry, a new desired manager is assigned (e.g., randomly, or using the same process as was used to initialize table 128), or alternatively no device manager may be assigned (eventually, it is highly likely that a trigger condition will result in a device manager servicing the device and becoming the desired manager).

If a device manager is added to the network, table 128 can be re-initialized based on all of the device managers (e.g., including the newly added device manager). Alternatively, table 128 may not be re-initialized, but eventually, due to the trigger conditions, the newly added device manager will become the desired manager for some of the devices in the network.

The trigger condition discussed herein may be a static condition (e.g., always a 5% chance a non-desired manager will service a device), or alternatively may be a dynamic condition. For example, the trigger condition may start at a high value (e.g., a 50% chance a non-desired manager will service a device) when-device service table 128 of FIG. 2 is initialized, and then decrease to a lower value (e.g., a 5% chance). The decrease in probability that a non-desired manager will service a device can occur as a function of different factors. For example, it may be a function of time (e.g., drop by 1% every hour) or a function of the frequency with which the trigger condition being satisfied results in changing of the desired manager (e.g., decrease the probability as the frequency decreases).

Situations can also arise where the probability that a non-desired manager will service a device can also be increased. For example, if the frequency with which the trigger condition being satisfied results in changing of the desired manager exceeds a threshold amount, the probability can be increased. By way of another example, one device manager may be significantly faster than other device managers in servicing devices (e.g., due to its computational capacities or its location in the network), which can result in a very unequal workload distribution. Workload equality can be readily determined by analyzing device service table 128 and determining how many devices each manager is the desired manager for. If such an unequal workload distribution is detected, the trigger condition can be increased (e.g., from a 5% chance to a 15% chance), which results in the trigger condition being satisfied more frequently and the non-desired managers servicing the devices more frequently.

If the trigger condition is dynamic, one or more modules are responsible for adjusting the trigger condition. In one implementation, a centralized module such as selection module 140 of FIG. 2 is responsible for adjusting the trigger condition. Selection module 140 has access to table 128 and thus can readily detect unequal workload distribution. Additionally, module 140 may be responsible for changing the desired manager in table 128 and thus has ready access to the frequency with which the trigger condition being satisfied results in changing of the desired manager. In another implementation, device selection modules 124 can communicate information with one another as necessary (e.g., the frequency with which the trigger condition being satisfied results in each changing the desired manager for a device), and modules 124 can be responsible for adjusting the trigger condition.

Additionally, the trigger condition may be the same for all device managers in the network, or alternatively may be different values for different device managers. For example, a newly added device manager may have a trigger condition with a higher value than the other device managers. By way of another example, a device manager may determine that its workload is significantly less than the workload of other device managers, and in response to this determination may increase the value of its trigger condition.

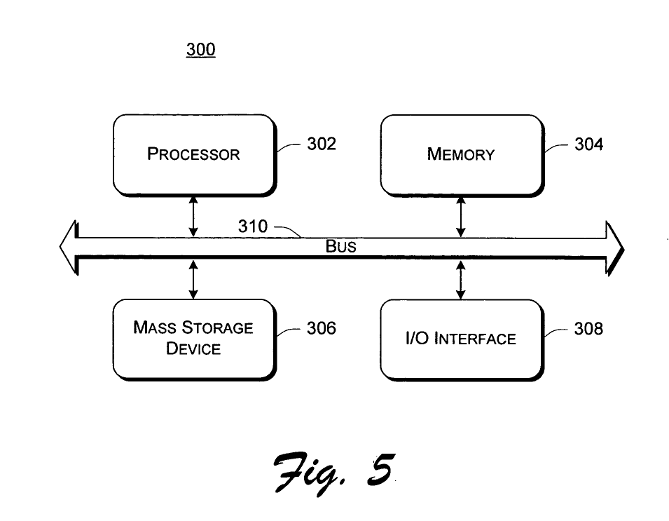

FIG. 5 illustrates an exemplary computer 300 in additional detail. Computer 300 can be, for example, a device manager 104 of FIG. 1 or FIG. 2, or a device 102 of FIG. 1 or FIG. 2. Computer 300 represents a wide variety of computing devices, such as desktop PCs, workstations, portable computers, dedicated server computers, multi-processor computing devices, Internet appliances, gaming consoles, personal digital assistants (PDAs), handheld or pen-based computers, microcontroller-based electronic devices, cellular telephones, and so forth.

Computer 300 includes a processor 302, a memory 304, a mass storage device 306, and an input/output (I/O) interface 308, all coupled to a bus 310. Bus 310 represents one or more buses in computer system 300, such as a system bus, processor bus, accelerated graphics port (AGP), peripheral component interconnect (PCI), universal serial bus (USB), and so forth. The bus architecture can vary by computing device as well as by manufacturer. I/O interface 308 is a conventional interface allowing components of computer 300 (e.g., processor 302) to communicate with other computing devices via a network. I/O interface 308 may be, for example, a modem, a network interface card (NIC), and so forth.

Memory 304 represents volatile and/or nonvolatile memory used to store instructions and data for use by processor 302. Typically, instructions are stored on a mass storage device 306 (or nonvolatile memory) and loaded into a volatile memory 304 for execution by processor 302. Additional memory components may also be involved, such as cache memories internal or external to processor 302. Various embodiments of the invention may be implemented, at different times, in any of a variety of computer readable media that is part of, or readable by, computer 300. For example, such computer readable media may be mass storage device 306, memory 304 or a cache memory, a removable disk (not shown) that is accessible by processor 302 or another controller of computer 300 (such as a magnetic disk or optical disk), and so forth.

Computer 300 is exemplary only. It is to be appreciated that additional components (not shown) can be included in computer 300 and some components illustrated in computer 300 need not be included. For example, a display adapter, additional processors or storage devices, additional I/O interfaces, and so forth may be included in computer 300, or mass storage device 306 may not be included.

The discussions herein refer primarily to software components and modules that can be executed by a computing device. It is to be appreciated, however, that the components and processes described herein can be implemented in software, firmware, hardware, or a combination thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method, implemented by a computing device, the method comprising:
sending a service request to a device, wherein the service request is a request for data relating to the operation of the device; and
determining, based at least in part on an amount of time taken to service the device, whether the computing device is to be identified as typically servicing the device.

2. A method as recited in claim 1, wherein the determining comprises:
checking whether the amount of time taken to service the device is less than a decision threshold; and
if the amount of time taken is less than the decision threshold, then determining that the computing device is to be identified as typically servicing the device.

3. A computer implemented method comprising:
checking an amount of time that a manager device took to service another device; and
determining, based at least in part on the amount of time, whether the manager device is a desired manager of the other device.

4. A method as recited in claim 3, wherein the determining comprises:
checking whether the amount of time is less than a decision threshold; and
if the amount of time is less than the decision threshold, then determining that the manager device is the desired manager of the other device.

5. A method as recited in claim 3, wherein the manager device was not, when servicing the other device, the desired manager of the other device.

6. A method as recited in claim 3, wherein the method is implemented by the manager device.

7. A method as recited in claim 3, wherein the method is implemented by a central database.

8. One or more computer readable media having stored thereon a plurality of instructions that, when executed by one or more processors of a device manager, causes the one or more processors to perform acts comprising:
identifying a device to be serviced;
checking whether the device manager is a desired manager for the device;
if the device manager is the desired manager for the device, then servicing the device; and
if the device manager is not the desired manager for the device, then checking whether a trigger condition is satisfied and servicing the device if the trigger condition is satisfied.

9. One or more computer readable media as recited in claim 8, wherein identifying the device to be serviced comprises selecting the device from a table accessible to the device manager.

10. One or more computer readable media as recited in claim 8, wherein identifying the device to be serviced comprises receiving an indication of the device from a central database.

11. One or more computer readable media as recited in claim 8, wherein the plurality of instructions further cause the one or more processors to perform acts comprising updating a last service time for the device.

12. One or more computer readable media as recited in claim 8, wherein if the device manager is not the desired manager for the device and if the trigger condition is satisfied, then the plurality of instructions further cause the one or more processors to perform acts comprising:
checking whether a time taken by the device manager to service the device is less than a decision threshold; and
if the time taken is less than the decision threshold, then identifying the device manager as the desired manager for the device.

13. One or more computer readable media as recited in claim 12, wherein identifying the device manager as the desired manager for the device comprises identifying the device manager in a table entry corresponding to the device.

14. One or more computer readable media as recited in claim 12, wherein the decision threshold is equal to the amount of time taken by the last desired manager of the device to service the device.

15. One or more computer readable media as recited in claim 12, wherein the plurality of instructions further cause the one or more processors to perform acts comprising:
checking, for a plurality of device managers, a frequency with which the trigger condition is satisfied and results in a device manager being identified as a desired manager for a device;
checking whether the frequency exceeds a threshold amount; and
increasing a probability that the trigger condition will be satisfied if the frequency exceeds the threshold amount.

16. One or more computer readable media as recited in claim 12, wherein the plurality of instructions further cause the one or more processors to perform acts comprising:
checking, for a plurality of device managers, a frequency with which the trigger condition is satisfied and results in a device manager being identified as a desired manager for a device;
checking whether the frequency is below a particular amount; and
reducing a probability that the trigger condition will be satisfied if the frequency exceeds the threshold amount.

17. One or more computer readable media as recited in claim 8, wherein checking whether the device manager is a desired manager for the device comprises checking whether the device manager is identified in a table entry corresponding to the device.

18. One or more computer readable media as recited in claim 8, wherein checking whether the trigger condition is satisfied comprises:
generating a value;
determining whether the value is within a range of trigger values; and
determining that the trigger condition is satisfied if the value is within the range of trigger values.

19. One or more computer readable media as recited in claim 8, wherein checking whether the trigger condition is satisfied comprises:
generating a random value;
determining whether the random value is less than a particular value; and
determining that the trigger condition is satisfied if the random value is less than the particular value.

20. One or more computer readable media as recited in claim 8, wherein the plurality of instructions further cause the one or more processors to perform acts comprising altering the trigger condition over time.
